(19) United States
(12) Patent Application Publication
(10) Pub. No.: US 2005/0136373 A1
(43) Pub. Date: Jun. 23, 2005

(54) Flexible translucent protective covers used to protect dental appliances from rigid light emitting devices

(75) Inventors: Dan E. Fischer, Sandy, UT (US); Bruce S. McLean, Sandy, UT (US); Steven J. Brattesani, San Francisco, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: ULTRADENT PRODUCTS, INC., South Jordan, UT (US)

(21) Appl. No.: 11/045,166

(22) Filed: Jan. 28, 2005

Related U.S. Application Data
(62) Division of application No. 10/423,121, filed on Apr. 25, 2003.

(51) Int. Cl. A61C 3/00; A61C 1/16

(52) U.S. Cl. 433/29; 433/116

(57) ABSTRACT

A flexible protective cover cushions the impact of a rigid light emitting device when placed in contact with a patient's teeth or a dental appliance. The protective cover includes a base configured to attach to a rigid light emitting device, and a flexible translucent body. The body includes a first and second end. Light from the light emitting device enters the cover through the first end and exits through the second end. The flexible cover may be made of polyurethane, silicone, flexible polyethylene, or another elastomer.

### CROSS-REFERENCE TO RELATED APPLICATIONS

The present application is a divisional application of U.S. patent application Ser. No. 10/423,121 filed Apr. 25, 2003, entitled “Flexible Translucent Protective Covers Used to Protect Dental Appliances from Rigid Light Emitting Devices”, which is incorporated herein by reference.

### BACKGROUND OF THE INVENTION

1. The Field of the Invention

The present invention relates to the field of dentistry, more particularly to dental light emitting devices used to cure polymerizable adhesive resins.

2. The Relevant Technology

Light curing devices are employed to polymerize and cure light curable compositions (also referred to herein as adhesives resins) in a variety of industries. Light curing devices include a light source which emits light energy for curing a light curable composition. In the field of dentistry, for instance, light curing devices are often employed to polymerize and cure light curable compositions, such as light curable composites, adhesives, and other polymerizable compositions containing photoinitiators. By way of example, a light curable bonding adhesive is often employed to attach a dental appliance such as a veneer to a dental surface. The adhesive is applied to the surface to be bonded, after which the veneer is placed against the tooth. The light curing device is then directed towards the veneer and actuated for a selected illumination time, emitting light energy into the adhesive. Because veneers are translucent, the light from the curing device passes through the veneer to the light curable adhesive. The light energy polymerizes the adhesive, maintaining the veneer firmly in place.

Typical light curing devices include a rigid lens or light guide to direct and collimate light into the area to be treated. To cure the light curable composition and bond the dental appliance to the tooth substrate, the dental light curing device is pushed against the veneer as light energy is emitted to properly seat the appliance to the substrate. The hard touch contact between the rigid lens or light guide and the surface to be treated (e.g. a patient's tooth or a dental appliance) can cause difficulties. Hard touch contact can result in breaking or cracking of the dental appliance (e.g. a veneer) as it is pressed into place. In addition, it can be difficult for the rigid lens or light guide of the dental curing light device to adapt to irregular tooth or other structure.

In view of the foregoing, there is a need to protect dental appliances and or surfaces from rigid surfaces of dental curing lights and lenses that may be attached thereto.

### BRIEF SUMMARY OF THE INVENTION

The present invention is directed to a flexible resilient protective cover used to protect dental appliances from rigid light emitting devices used to light cure a dental adhesive. The protective cover cushions the impact of a rigid light emitting device when placed in contact with a dental substrate, such as patient's tooth or a dental appliance (e.g., a veneer). The protective cover is transparent or translucent to curing wavelengths emitted from the light emitting device, allowing at least a portion of the curing wavelengths to pass through the cover and into the composition to be cured.

The protective cover comprises a base configured to attach to a rigid light emitting device and a flexible translucent body having a first end proximal to the base through which light energy emitted by a light emitting device enters, and a second end distal to the base through which light energy exits. The cover may be integrally attached to a light emitting device, or alternatively may be configured to releasably attach to light emitting device. If attachable, the protective cover may be connected by any mechanical means, for example a snap fit, a friction fit, a threaded coupling, or a bayonet coupling. The protective cover may be used in a variety of restorative procedures, including placement of dental appliances, such as overlays, inlays, veneers and crowns.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1-3 illustrate exemplary embodiments of protective covers attached to various light emitting devices;

FIGS. 4A-4E illustrate exemplary surfaces of protective covers according to the invention;

FIGS. 5A-5C illustrate the use of an exemplary protective cover with a suction tip to temporarily hold a dental appliance and then bond it to a substrate surface.

### DETAILED DESCRIPTION OF THE PREFERRED EMBODIMENTS

As used herein, the term “dental appliance” or “appliance” means any dental prosthesis or other appliance such as an overlay, inlay, veneer, crown, or other prosthesis to be bonded to a tooth.

As used herein, the term “lens” or “light guide” refers to any object through which light may travel and does not inherently imply any characteristics for focusing or collimating light.

As used herein, the term “translucent” refers to the ability of at least some curing light energy to be transmitted through the “translucent” object. It also includes transparent, which allows all or nearly all curing light energy to be transmitted through the object.

The term “footprint,” as used herein, is generally made with reference to the cross-sectional shape of light emitted from a light emitting device. The general shape and dimensions of a footprint can generally be identified by placing an object (e.g., a flat object) in front of a light source and observing the area illuminated by the light source.

The flexible resilient protective cover provides a soft touch interface for cushioning the impact of the rigid light emitting device when placed in contact with dental substrate, such as a patient's teeth or a dental appliance. The protective cover includes a base and a flexible translucent body. The base is configured to attach to a rigid light emitting device. The body includes a first and second end. The first end is proximal to the base, and is the end through which light energy emitted by the attached light emitting device enters. The second end, through which light energy exits, is distal to the base.

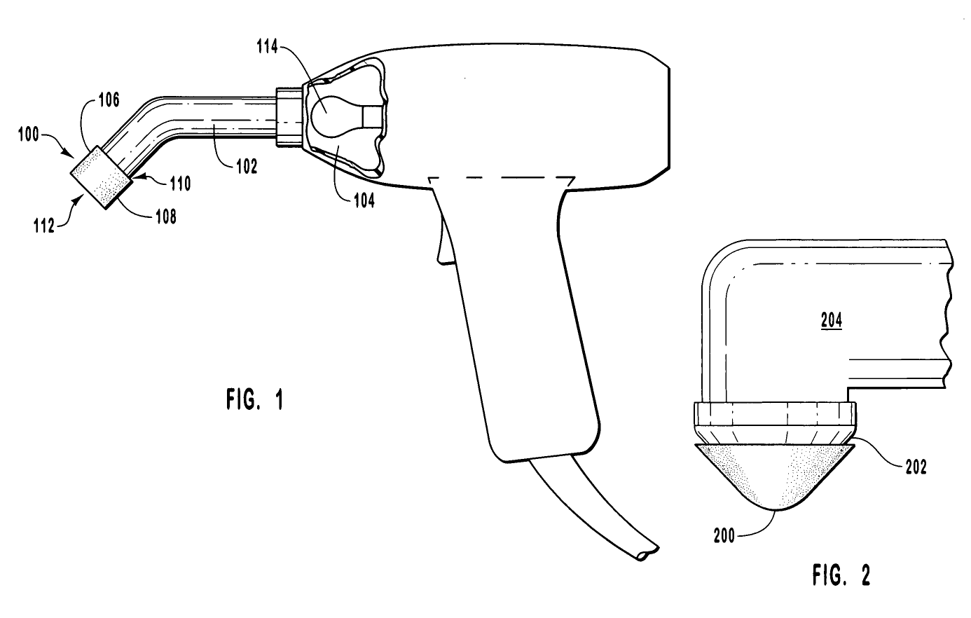

The protective cover may be used with various types of light emitting devices, including dental curing lights, optionally in combination with a fiber optic light guide and/or one of various possible lenses. FIG. 1 illustrates a flexible protective cover 100 placed on a fiber optic light guide 102 attached to a dental light curing device 104. Protective cover 100 includes a base 106 and a flexible translucent body 108. Body 108 includes a first end 110 proximal to base 106 through which light energy emitted by fiber optic light guide 102 enters and second end 112 distal to base 106 through which light energy exits.

Base 106 is configured to attach to a light emitting device (e.g. fiber optic light guide 12). It may be releasably attachable with a friction fit, a snap fit, a threaded coupling, a bayonet coupling, or any other type of coupling. Alternatively, protective cover 100 may be integrally attached to the fiber optic light guide or other light emitting device, such as with an adhesive, by welding, or with other non-removable coupling.

Light energy is generated by light source 114, which may include a halogen bulb, an incandescent bulb, a fluorescent bulb, a laser source, one or more LEDs or LED arrays, or any other light source. The light energy enters fiber optic light guide 102, where it is directed towards the protective cover 100. Light energy enters the flexible protective cover through first end 110. It passes through the cover 100, exiting through second end 112.

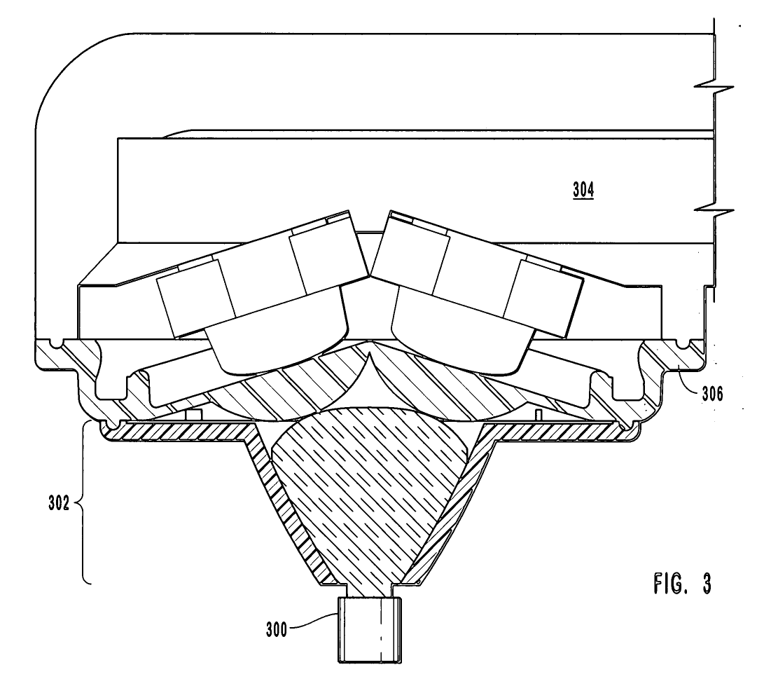

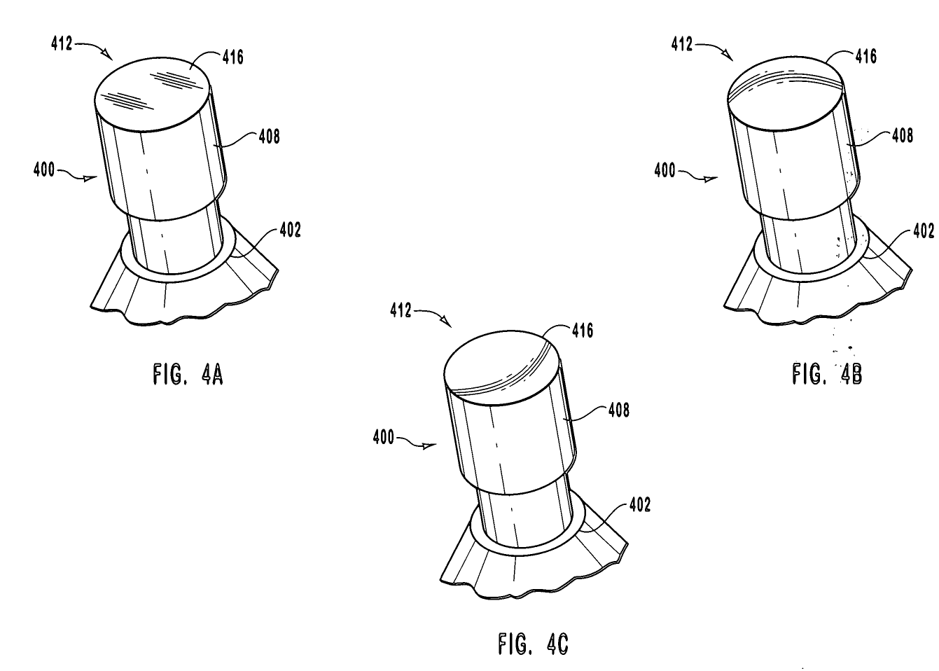

FIG. 2 illustrates a flexible protective cover 200 placed over a conical lens 202 attached to a dental light curing device 204, while FIG. 3 illustrates a flexible protective cover 300 placed over, or integrally part of, a spot curing lens 302 attached to a dental light curing device 304, e.g., with an intermediate focusing lens 306 interposed between the spot curing lens 302 and the curing light 304.

Although illustrated with a fiber optic light guide, a conical lens, and a spot curing lens (FIGS. 1-3), the flexible protective covers according to the present invention may be used with any light guide or lens, or may be attached directly to a dental light curing device or other light emitting device without a light guide or lens, if desired.

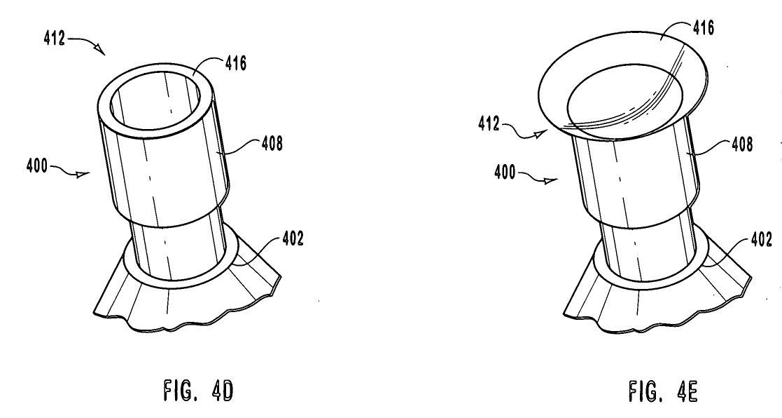

FIGS. 4A-4E illustrate various exemplary flexible protective covers 400. Each exemplary cover 400 is preferably removably attached to a light emitting device by a friction fit, although other couplings could be used, or the cover could be integrally attached to light emitting device 402. Each cover 400 is illustrated with a friction fit and is partially removed from light emitting device 402 to better illustrate the friction fit.

FIG. 4A illustrates a protective cover 400 having a cylindrical body 408. The second end 412 of the protective cover 400 includes a flat surface 416. FIG. 4B illustrates a protective cover 400 that includes a cylindrical body 408 and a second end 412 having a convex surface 416. FIG. 4C illustrates a protective cover 400 that comprises a cylindrical body 408 and a second end 412 having a concave surface 416. FIG. 4D illustrates a protective cover 400 including a cylindrical body 408 that is hollow such that the second end 412 includes a circular rim 416. FIG. 4E illustrates a protective cover 400 comprising a cylindrical body 408 and a second end 412 having a suction tip 416 (e.g., a suction cup). The suction tip 416 can be releasably attached to a dental appliance in order to facilitate placement of the dental appliance onto a substrate surface, such as a tooth. It will be appreciated, however, that any protective cover according to the invention may be modified to temporarily adhere to a dental appliance by means of a sticky material or other temporary adhesive material known in the art.

The base and flexible translucent body of the flexible protective covers are preferably formed of a translucent, soft material with a durometer hardness of about 40 to about 100, more preferably about 50 to about 90, and most preferably about 60 to about 80. A preferred material is PELLATHANE, a polyurethane manufactured by Dow Chemical (p/n 2102-70). Although it is preferable to form the protective cover of such a material, it may be formed of any material sufficiently soft to provide a soft touch interface and cushion the impact between the protective cover and the dental appliance. Examples of suitable materials include polyurethane, silicone, flexible polyethylene, rubber, or any other elastomer.

Protective covers 400 such as those illustrated in FIGS. 4A-4E may have any suitable diameter. Preferably, the cover has a diameter of about 0.1 mm to about 5 mm, more preferably about 0.5 mm to about 4 mm, and most preferably about 1 mm to about 3 mm.

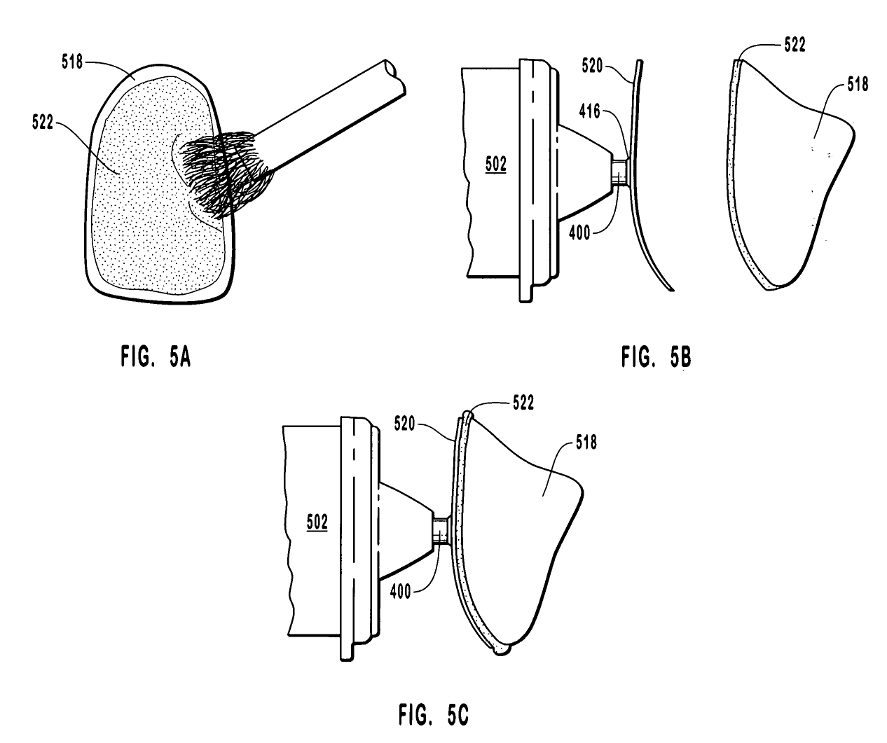

In order to illustrate an exemplary method of using the flexible resilient protective cover of the present invention, attention is directed to FIGS. 5A-5C, which illustrate the use of a light emitting device 502 with a protective cover 400 that includes a suction tip 416. FIG. 5A illustrates a tooth surface 518 being prepared for bonding to a dental appliance 520 (FIG. 5B). A light curable composition 522 is applied to the surface to be bonded. It may be applied to the appliance 520, the tooth 518, or both.

FIG. 5B illustrates the dental appliance 520 attached to a protective cover 400 connected to a light emitting device by means of a suction tip 416 at an end of the protective cover 400. The flexible resilient protective cover 400 provides a soft touch interface to cushion the impact of the light emitting device 502 when pressed against the appliance 520 (FIG. 5C) during positioning of the appliance 520 against the tooth surface 518. Once positioned correctly, the dental practitioner uses the light emitting device 502 to cure at least a portion of the light curable composition 522 through the appliance 520. The suction tip 416 of the flexible protective cover 400 may then be removed from the dental appliance 520.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A light curing system for use in cushioning the impact of a rigid light emitting device when placed in contact with a patient's teeth or a dental appliance, the light curing system comprising:
a rigid light emitting device; and
a flexible protective cover for use in cushioning the impact of the rigid light emitting device when placed in contact with a patient's teeth or a dental appliance, the protective cover comprising:
a base configured to attach said flexible protective cover to the rigid light emitting device; and
a flexible translucent body having a first end proximal to said base through which light energy emitted by said light emitting device enters and a second end distal to said base through which light energy exits.

2. A light curing system as recited in claim 1, wherein said rigid light emitting device includes a light source that comprises at least one of a halogen bulb, an incandescent bulb, a fluorescent bulb, or a laser source.

3. A light curing system as recited in claim 1, wherein said rigid light emitting device includes a light source comprising at least one LED or LED array.

4. A light curing system as recited in claim 1, wherein said rigid light emitting device includes a fiber optic light guide to which the flexible protective cover is attached.
